(19) United States
(12) Patent Application Publication
(10) Pub. No.: US 2006/0032114 A1
(43) Pub. Date: Feb. 16, 2006

(54) Fortified mulch

(76) Inventors: Michael Krysiak, Green Bay, WI (US); Daneil P. Madigan, Green Bay, WI (US); Bryan A. Fish, Green Bay, WI (US); Ronald D. Eichhorn, Green Bay, WI (US)

Correspondence Address: WEISS & WEISS;Suite 251, 300 Old Country Road, Mineola, NY, 11501, US

(21) Appl. No.: 11/235,390

(22) Filed: Sep. 26, 2005

Related U.S. Application Data
(63) Continuation of application No. 09/510,782, filed on Feb. 23, 2000, now abandoned.

(51) Int. Cl. A01G 7/00

(52) U.S. Cl. 47/9

(57) ABSTRACT

The invention relates to a composition and method for making mulch fortified with fertilizers via an agglomeration/granulation process.

### RELATED APPLICATIONS

The following application is a continuation application of Ser. No. 09/510,782.

### FIELD OF THE INVENTION

The invention relates to a composition and method for making mulch fortified with fertilizers via an agglomeration/granulation process.

### BACKGROUND OF THE INVENTION

Mulches are commonly applied over grass seed beds. Mulches help to increase seed germination and decrease soil erosion allowing seeds to become firmly established in the seeded area. Mulches typically consist of straw, wood shavings, or paper. In the prior art mulches are mixed with water and agitated in a holding tank, and then sprayed onto a seed bed. Some mulches are woven into blankets that are designed to be laid down over seed beds. Some mulches are chemically bonded natural fiber spray-applied mulches. These mulches use a vegetable gum binder such as guar gum to bind together natural fibers.

Most mulches are loose configurations of unbonded fibers that easily wash away Paper-based mulches tend to bond into a paper mache-like mat that inhibits oxygen and sunlight transfer, and the ability of seedlings to emerge through the mulch, effecting vegetation establishment. Chemically-bonded mulch forms an almost impenetrable layer over the seed bed that is poor at passing oxygen and water through to the seed bed.

U.S. Pat. No. 5,942,029 discloses a mechanically-bonded, water-absorbent fiber mulch including natural and crimped synthetic fibers that are intimately mixed to form a mechanically-bonded fiber mulch.

U.S. Pat. No. 5,916,027 discloses mulch flakes made from finely divided paper and/or wood, and a surfactant. The flakes contain fertilizer.

### SUMMARY OF THE INVENTION

The present invention relates to a process for creating fortified mulch through an agglomeration/granulation process. A moist paper fiber based product is impregnated with NPK (nitrogen, phosphorus, potassium) fortifiers in a mixer. The paper product is combined with the NPK fortifiers either before, or after entry into a mixer. The mixer performs work that results in an agglomerated (or granulated) product that is a homogeneous blend of the paper product and NPK fortifiers. This product is then dried to a desired level of moisture and screened as necessary. A binding agent can be added at the mixer to enhance the agglomeration/granulation process. If a binding agent is added the paper fiber based product need not be moist. To increase the percent of on-sized product, a size reduction operation can be performed on the paper fiber product prior to entry into the mixer.

These and other features and advantages of the preferred embodiment of the present invention will become apparent from the detailed description of the preferred embodiments.

### DETAILED DESCRIPTION OF THE INVENTION

The present invention relates to a process for creating fortified mulch through an agglomeration/granulation process. A paper fiber based product, which can be moist, is impregnated with NPK fortifiers in a mixer. The mixer is preferably a pin mixer but can also be a pan pelletizer, paddle mixer, drum granulator or other type of mixer. The pin mixer is preferably a double helix pin arrangement. The paper fiber based product is preferably comprised of a by product of a paper making process. Sewage sludge can be used to create the fortified mulch rather than paper fibers.

Below is an example of how a fortified mulch product can be made using a pin mixer.

### EXAMPLE

In a pin mixer, agglomeration occurs, when radially extended pins mounted on a high velocity central rotor shaft, in a stationary cylindrical shell impart agitation forces on the material and sprayed liquid binder. This causes a tumbling, turbulent movement resulting in densification.

Pin Arrangement

Several different types of pin mixers were tested to determine the best pin arrangement for creating a fortified mulch. The double helix pin arrangement resulted in a round, more uniform pellet. The internal casing length and diameter were 23 inches and 6 inches, respectively. The dimensions of the shaft and pins included 2-inch diameter shaft and two-inch length pins. The tip speed was not calculated. It was concluded that varying the speed (RPM) effected the pellet size. Increasing the speed caused a decrease in particle size. Also, the higher the speed (RPM) the fewer number of large chunks came through. It is important to note that initial grinding of wet paper sludge drastically reduced chunks discharging the pin mixer. It was found that the pin mixer when set at 650 RPM resulted in a product that consisted largely of end-size (−6, +16) product. Although horsepower draws were not conducted, it was apparent that this material did not require a motor that was larger than FEECO pin mixer specifications. This material created a shell, but its amperage did not increase. Mulch through the pin mixer readily agglomerated and the discharged product was uniform in size and shape.

Retention Time

The FEECO unit was inclined to analyze any improvement of product caused by an increased retention time. No increase in retention time was noticed. A test was conducted to determine the retention time of the. A scoop full of wet paper was spray painted and fed into the feed hopper. Material began to discharge at 2 seconds and ended at 23 seconds. The majority of the material took 8 seconds. Small particles has short retention time while larger particles took longer.

Pin Mixer: Material Feed Rates

Ground Wet Paper Sludge

Wet paper was added at 33 lbs/hr the product was not uniform and round, so the feed was decreased to 200 lbs/hr. A uniform product was achieved at this rate. It was preferable to use a rate of 200 lbs/hr, however, a rate between 200 and 300 lbs./hr. is also acceptable. The wet paper sludge bridged in the screw feeder. The 3″ feeder was the most consistent.

Water

An added 36-lbs./hr. water was metered into the pin mixer. The percent moisture in the paper was 52.3% water. A total of 140.6 lbs./hr of moisture is introduced when 200 lbs./hr of wet sludge is metered into the pin mixer.

NPK

The NPK fortifiers were added to the pin at a rate of 28 lbs./hr. A vibratory feeder was required to feed such a low rate. The fertilizer had to be screened prior to addition into the feed hopper.

Coating Drum

Wet Mulch Pellets

The wet mulch pellets were hand fed into a rotary drum had no apparent problem with varied low or high feed rates. The rotary dryer placed limitations onto the coating drum feed rate. The majority (>90%) of agglomeration is done in the pin mixer. Since the material sent into the coating drum was in the form of a pellet, the material readily rolled. The retention time of the mulch was approximately 1-2 minutes shorter than for an encapsulated seed (4-5 minutes).

Dryer

The pin mixer was not the only component limiting the feed rate, for the rotary dryer was not able to sufficiently dry the NPK fortified paper pellets. The increase in moisture also forced the reduction in the feed rates.

The inlet and outlet air temperatures were 1100 degrees Fahrenheit and 180 F, respectively. The sample at these settings had a material outlet temperature ranging from 150 to 175 degrees Fahrenheit and moisture content of 2.5%.

Sieve Analysis

A sieve analysis was conducted with the use of a screen. The end-size portion was between 6 and 16 mesh. A three-hour continuous run was produced, dried, and screened. The results concluded a total of 300 lbs. of material; 206 lbs. on size (68.7%), 53 lbs. under-size (17.7%), and 41 lbs. over size (13.7%).

While the invention has been particularly shown and described with reference to the preferred embodiment of the present invention, it will be understood by those skilled in the art that the foregoing and other changes in form may be made therein without departing from the spirit and scope of the invention.

1. An agglomeration/granulation method for creating a fortified mulch consisting essentially of;
adding paper fibers to a pin mixer;
adding nitrogen, phosphorous and potassium fortifiers and a binding agent before or at said mixer;
mixing and tumbling said paper fibers, said fortifiers and said binding agent in said mixer;
drying contents of said mixer.

2. The method of claim 1 wherein the pin mixer is replaced with a pan pelletizer.

3. The method of claim 1 wherein the pin mixer is replaced with a paddle mixer.

4. The method of claim 1 wherein the pin mixer is replaced with a drum granulator.

5. The method of claim 1 wherein said pin mixer has a double helix pin arrangement.

6. The method of claim 1 wherein said paper fibers are comprised of a by-product of a paper making process.

7. The method of claim 1 wherein said paper fibers are replaced with sewage sludge.

8. An agglomerated/granulated mulch product made by a mixing and tumbling operation that is comprised of nitrogen, phosphorous and potassium fortifiers and paper fibers.

9. The method of claim 1 further comprising:
performing a size reduction operation on said paper fibers prior to adding said paper fibers to said mixer.
